(19) United States
(12) Patent Application Publication
(10) Pub. No.: US 2009/0276426 A1
(43) Pub. Date: Nov. 5, 2009

(54) Semantic Analytical Search and Database

(75) Inventors: Nikolai N. Liachenko, Porter Ranch, CA (US); Cory M. Isaacson, Broomfield, CO (US)

Correspondence Address: HENSLEY KIM & HOLZER, LLC, 1660 LINCOLN STREET, SUITE 3000, DENVER, CO, 80264, US

(73) Assignee: RESEARCHANALYTICS CORPORATION, Broomfield, CO (US)

(21) Appl. No.: 12/435,338

(22) Filed: May 4, 2009

Related U.S. Application Data
(60) Provisional application No. 61/050,169, filed on May 2, 2008.

(51) Int. Cl. G06F 17/30; G06F 15/18

(52) U.S. Cl. 707/6; 706/12; 707/5; 707/3; 704/9; 707/E17.015; 707/E17.014; 707/E17.108

(57) ABSTRACT

A system and method for of identifying a semantic meaning of searchable elements are provided. In one implementation, a system includes an adaptive machine-learning module including a pattern recognition processor. The pattern recognition processor is configured to recognize searchable elements in source information and identify a semantic meaning of the searchable elements based on contingency measures of their relationships within the source information without requiring a predefined ontology of terms. In another implementation, a method includes recognizing searchable elements in source information; and identifying a semantic meaning of the searchable elements using a pattern recognition processor based on contingency measures of searchable element relationships within the source information without requiring a predefined ontology of terms. A database index that logically represents a hash map from integer keys to hash sets, wherein the database index is configured to use joint counters to determine set intersections of searchable elements for relational discovery is also provided.

### CROSS-REFERENCE TO RELATED APPLICATIONS

The present application claims benefit of priority to U.S. Provisional Patent Application No. 61/050,169 entitled “Semantic Analytical Search and Database: The System, Indexing and Process” and filed on May 2, 2008 specifically incorporated by reference herein for all that it discloses or teaches.

### BACKGROUND

Known search engines use a number of different search approaches. A context-based search approach, for example, requires additional information beyond a standard query. A “Semantic Web” approach use metadata incorporated into the data sources by the creators of those sources. The Semantic Web approach, however, requires those creators to create that metadata and make it available to the search engine. Integration search approaches are designed to semantically link a large variety of information elements found in different sources. While the known integration search applications integrate sources of information, these integration search engines do not extract an integral meaning of a whole set of relevant documents.

Concept, ontology, annotation, and categorization search applications are based on a predetermined ontology conceptual structure and enable the user to link different documents by generalization, but require a predetermined ontology structure or a conceptual map. Natural language processing search applications are based on automatic language analysis and provide semantic information to the users of datasets. The core parts of such applications are language processors, which analyze grammatical and syntactical relations in texts. They often work in collaboration with ontology-based categorization systems. Natural language processing search applications, however, require linguistic categories and have a relatively narrow scope of analysis. Summarization search applications describe the content of big collections of sources in a short textual form. Summarization search applications, however do not discover quantitative and structural relations between elements of interest. Semantic database applications provide database storage and search processes facilitating retrieval of information “by content” in contrast to direct instructions of what should be retrieved from where. Such systems are either based on ontology and on translation of semantic requests into relational languages (like SQL) or support higher levels of DBMS (for example, automatically create relational schemas from tree-like semantic structures). Underlying storages of the semantic databases are either identical to relational storages (i.e., emulate semantic structures inside RDBMS) or physically link units of storage imitating relevant ontology structures.

Hash use and storage applications either focus on using semantic information for linking poorly structured databases or solve performance problems usually encountered in the conventional hash-based search: reduction of resolution time and acceleration on approaches such as hash methods SHA1 and MD5.

### SUMMARY

A database, system and process for retrieval and analysis of semantic information from textual Web documents, relational databases, and XML databases are provided. The database, system and process discover and represent relations between terms (objects) requested in a user's query. This process is referred to as a “semantic analytical search.”

In one implementation, a database, system and/or process can include an adaptive machine learning (recognizer) module, comprising a pattern recognition processor. The pattern recognition processor can recognize searchable elements in text documents, information stored in a relational database, XML documents, and scanned images. The pattern recognition processor can further change its algorithm by using feedback from a statistical output of the system. The processor can be used to identify the semantic meaning of unique data elements (e.g., terms) based on contingency measures of their relationships, without requiring a predefined ontology of terms.

In another implementation, a database, system and/or process, a search can use a non-conventional index. In this particular implementation, the index logically represents a hash map from integer keys to hash sets and used for fast computation of counters for set intersections. This, in turn, supports high-speed, on-demand calculation of joint counters of elements (e.g., terms), which can be used for relation discovery. The elements, for example, can number in the tens of millions. This storage structure supports high-speed joint counters of elements and differs from systems that rely on traditional programmatic sort and index mechanisms.

In yet another implementation, a relation discovery process may depend only on cardinalities (counters) of different combinations of the requested elements (e.g., terms). The analysis can return descriptions of the discovered relations in the form of a vector-weighted graph, which can be transformed into a number of application-oriented representations (e.g., charts and verbal explanations of the most important features of the graph). The discovered relations can be used to infer semantic meaning of elements (e.g., terms) based on statistical algorithms and relationships of elements (e.g., terms) that are contained in fields of relational databases, semantic databases, scanned images and textual data of documents. The relation discovery process is based on index generated by the recognizer, providing results that are not dependent on a predefined ontology or user direction.

Other implementations are also described and recited herein.

### BRIEF DESCRIPTION OF THE DRAWINGS

FIG. 1 illustrates an example illustration of a relation graph built by a semantic analytical search application.

FIG. 2 illustrates an example an example implementation of a data collection system of a semantic analytical search application.

FIG. 3 illustrates an example storage structure for a semantic analytical search application.

FIG. 4 illustrates a schematic diagram of an example search process.

FIG. 5 illustrates an exemplary system useful in implementations of the described technology.

### DETAILED DESCRIPTION

A database, system and process for retrieval and analysis of semantic information from textual Web documents, relational databases, and XML databases are provided. The database, system and process discover and represent relations between terms (objects) requested in a user's query. This process is referred to as a “semantic analytical search.”

The search can be used to determine the “meaning” of elements in the user's request in the sense of the following semiotic definition (see, e.g., the web site en.wikipedia.org/wiki/Meaning_(semiotics)): “in semiotics, the meaning of a sign is its place in a sign relation, in other words, the set of roles that it occupies within a given sign relation.”

The stress on relation discovery distinguishes this approach from natural language processing, ontological categorization, and manual text annotation in the style of the “Semantic Web”. The present approach is closer to analytical knowledge discovery, and can be fully automated without requiring any repurposing, reformatting or human description and evaluation of data.

A semantic analytical search discovers semantic information during a search. The semantic analytical search can be considered as providing an opposite approach to a typical semantic web approach. Instead of people helping computers to understand documents by creating metadata for each source of information, the semantic analytical search approach enables computers to help people to understand the web content by automatically discovering semantic information. The discovered semantic information allows the semantic analytical search to extract an integral meaning of a set of relevant documents.

A semantic analytical search can also be independent of classification of terms. In one implementation, for example, relations can be discovered based on statistical properties of terms, not on a classification of those terms.

A semantic analytical search is also different from known natural language processing (NLP). In one implementation, for example, a semantic analytical search does not require linguistic categories (i.e., it is not NLP) and its scope of analysis is much broader than a separate text (e.g., a result of an analysis may integrate knowledge from the whole Internet or its large sub-sectors).

A semantic analytical search is also different from a summarization search application. A semantic analytical search application, for example, discovers quantitative and structural relations between elements of interest. In other words, it does not need to summarize the content of sources; it discovers relationships between particular entities by taking into account a large number of sources, and thus can be used to infer meaning and importance of selected terms in given fields.

A semantic analytical search is also different from semantic databases that suggest database storage and search processes facilitating retrieval of information “by content” in contrast to direct instructions of what should be retrieved from where. Such systems are either based on ontology and on translation of semantic requests into relational languages (like SQL) or support higher levels of DBMS (for example, automatically create relational schemas from tree-like semantic structures). Underlying storages of such semantic databases are either identical to relational storages (i.e., emulate semantic structures inside RDBMS) or physically link units of storage imitating relevant ontology structures.

A semantic analytical search, however, need not be a retrieval system, but rather provides a relation discovery system and a supporting storage can be designed for efficient calculation and reading of numeric information describing relations. Also unlike search engines that establish similarity between elements and files, a semantic analytical search focuses on discovery of correlations between terms derived from a pool of examples on a statistical basis (e.g., a purely statistical basis). Further, unlike search applications where an analysis of terms is based on a comparison with a set of predetermined terms and on the use of semantic relevance, a semantic analytical search provides a statistical and dynamic approach in which all compared terms are taken from the user query itself or discovered in the process of analysis.

A semantic analytical search is also different from typical hash use and storage applications that focus either on using semantic information for linking poorly structured databases or solve performance problems usually encountered in the conventional hash-based search (e.g., reduction of resolution time and acceleration on approaches such as hash methods SHA1 and MD5). In contrast to these types of hash use, a semantic analytical search can be based on counting without joining tables or avoiding time loss associated with hashes. A novel storage index structure including, for example, a map of hash maps can be used for fast calculation of joint counters.

For example, when a crawler navigates through a network (e.g., the Internet) and encounters words “New” and “York”, a parser originally may interpret them as separate terms. Later, after the statistics of term occurrences are analyzed, the database indexer will discover that the frequency of joint occurrences in this case is significantly higher than random and will include a new term “New York” in the index in addition to its separate components. This illustrates the adaptive nature of the parser. Unlike known methods of collocation analysis or search for stable word combinations, the approach here is broader and allows for the targeting discovery of highly dependent subsets, which can be treated as a separate entity in tasks requiring discovery of structure and data interpretation.

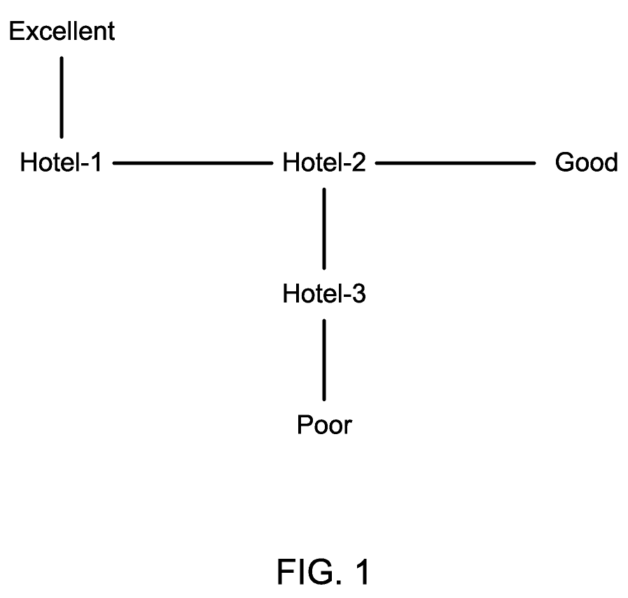

FIG. 1 illustrates an example illustration of a relation graph built by a semantic analytical search. During the search process, a user may be interested in studying how Internet publications compare web sites, blogs and other text documents regarding different hotels. In the example of FIG. 1, the process can include terms such as the names of hotels: “Hotel-1”, “Hotel-2”, “Hotel-3”, along with attributes of hotels such as “Excellent”, “Good” and “Poor”. In this implementation, the Semantic Analysis method and software engine uses counters of a combination of terms to determine the statistical relationship based on documents that reference each combination of terms. For the Internet example, each Web page can act as a unique usage identifier. It finds that “Hotel-1” is referenced by sites “site1”, “site5”, “site9”, “site22”, “site34” and “Excellent” is referenced by sites “site5”, “site22”, “site50”. The joint occurrences are in sources “site5”, “site22” and the joint counter is two. Therefore, the statistical analysis determines semantic meaning and significance of terms based on the frequency of usage of combinations of terms desired by the user determined by contingency measures as described below. In this example, if Hotel-1 has the most documents which mention it, plus the term “Excellent”, then this can be used to infer meaning and/or comparative opinions representative of those in the data set (in this case the Internet) regarding this hotel.

One important engineering problem with a search for intersections is the number of potential usage occurrences in the data set for a given term. For the Internet as a data set, for example, each term may be used tens of millions of times, and likewise, any related term can also be referenced in a very large number of instances. Therefore, in some implementations, an efficient search of a very large data set can be provided to find an intersecting set of documents that match both terms in order to allow for a practical analysis of such a large data set. In such an implementation, the search algorithm may be able to perform such a search in milliseconds or seconds.

In one particular implementation, hash set structures may be used for comparing sets to be intersected. In this implementation, the method and algorithm stores this data in set structures directly incorporated to a database index storage. The hash set may be used in such an implementation as a hash set comparison to extract semantic meaning and statistical importance of terms found in unstructured text.

When all counters are found, one or more appropriate application-related contingency measures for combinations of terms can be found and the strongest of them can be used to create a relation graph (shown in FIG. 1) using the derived numeric characteristics. Stronger statistical relationships in this example representation are indicated by the weight of the connecting link between terms.

Unlike popular search systems that find references to documents by key words, the proposed semantic analytical search system accepts a more semantic type of request closer to natural texts and returns results of structural and quantitative analysis of a whole set of relevant sources. This is opposed to traditional search engines that merely present the first few individual results of the potential set. As mentioned before, this type of response can be described as a “semantic analytical search”. Similarly, the described database structure supporting this search can be described a “semantic analytical database.”

A database structure that supports such a semantic analytical search is distinctly different from the support of a conventional reference-oriented search, and can also be unique in its application to the identification of relations, degrees of importance and the resulting semantic meaning from data stored in relational databases, XML documents, scanned images and text sources.

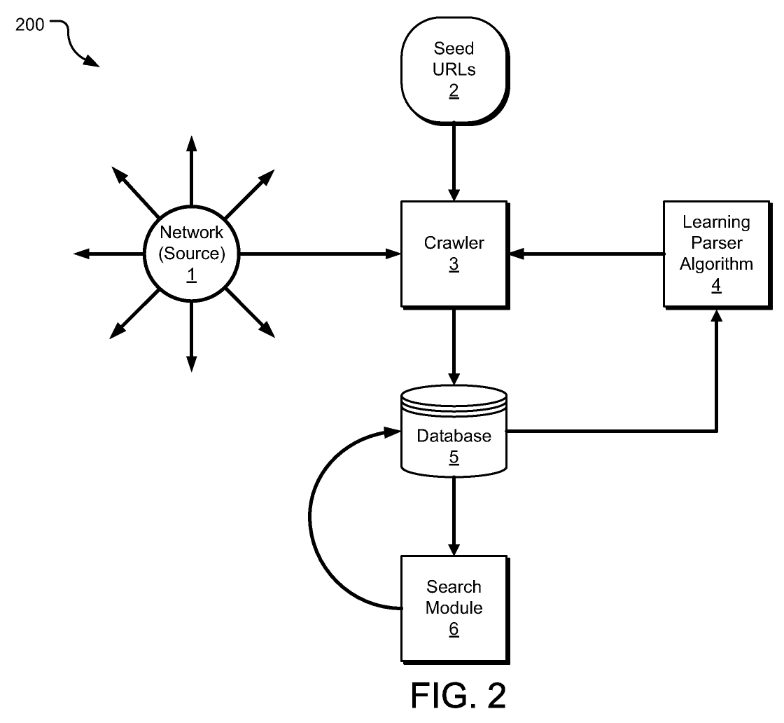

FIGS. 2-4 show an example implementation of a semantic analytic search system.

An example implementation of a data collection system is shown in FIG. 2. Data collection can be performed to identify searchable elements in sources (for example, terms), to store references to sources and to represent information in a way that enables the search system to rapidly calculate joint occurrences of different terms, even with sets of millions of term references. Navigation in the system of linked sources can be based on traditional crawling principles (depth-first search). In one implementation, for example, it starts with a set of predetermined references (e.g., a seed 2). A crawler 3 navigates through a network 1 and parses the sources by using an adaptive parser algorithm 4. The result of the parsing can be used as a set of terms with references to sources and a set of the detected hyperlinks to other sources. One distinguishing feature of the adaptive parser algorithm 4 is its learning capability; identification of terms depends on the previously collected statistics and calculation of contingency measures between units of information. The preferable contingency measure is application dependent. The results of the parsing are stored in a database 5, or other data storage device, which is used by the search module 6.

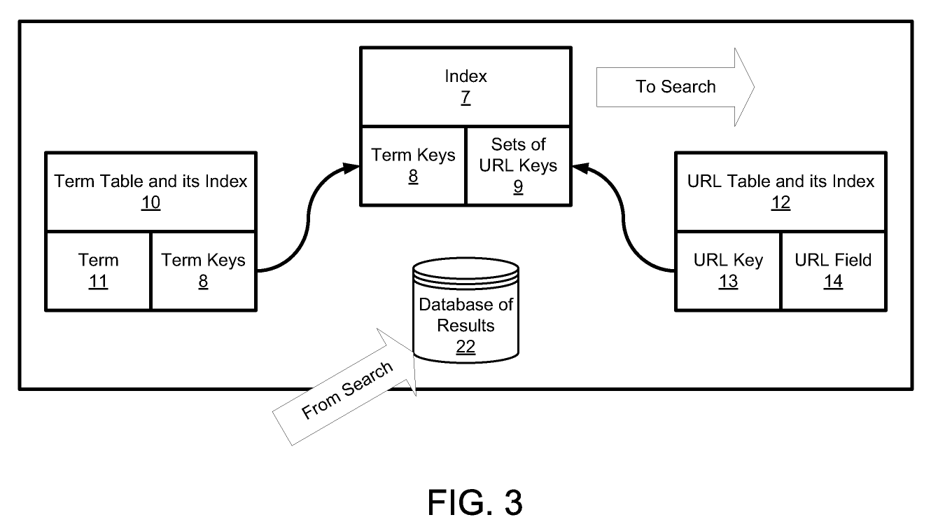

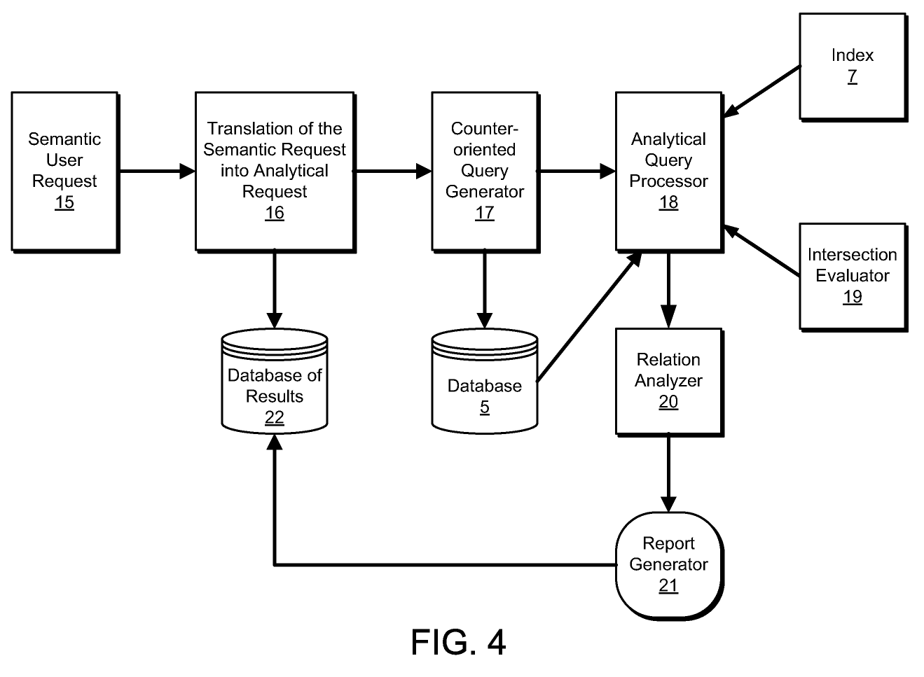

FIG. 3 shows an example storage structure for a semantic analytical search application. A central element of the storage structure is a search index 7, which in this implementation comprises a table with at least two fields: a numeric key 8 representing a term and a hash set of corresponding keys of term references (e.g., a URL or other usage instance identifier) 9. In one implementation, the entire table can be a hash map of integers to hash sets of integers. In this implementation, the term integer represents a given term. The hash set contains all of the instances where the term is used; one integer in the set representing a unique usage instance of the term. Correspondence between terms 11 and their integer keys 8 can be maintained by a term table 1O. Correspondence between usage instances (i.e., URL references in one example) 14 and their keys 13 can be maintained by a usage instance table 12. The database storage may also include a database of results 22 populated by the search process from user generated queries (shown below with respect to FIG. 4).

FIG. 4 illustrates a schematic diagram of an example search process. In this implementation, the search process starts with a semantic request 15 from a user. In a user view, the request 15 may be represented in many different forms: Graphical User Interface (GUI) forms, short free-style texts, from which the analytical engine selects entities and attributes (elements) of interest, specialized query builders or Resource Description Framework (RDF)-style query languages. The original request 15 is translated into the analytical request by a converter 16, which identifies the roles of elements in the user request 15 (terms which represent elements of interest and attributes). The next operation in this implementation is a counter-oriented query generator 17, which expresses the analytical request 15 in terms of the database tables and fields of FIG. 3. A query result is returned by the database 5 of FIG. 3 to an analytical query processor 18. The analytical processor 18 is responsible for a first step of the relation discovery process. It uses the index 7 and an intersection evaluator algorithm 19 for calculating joint counters. A second step of the relation discovery can be done by a relation analyzer 20, which builds a graph of strongest associations between user-defined elements. Information about computation of associations can be found in Alan Agresti, “Categorical Data Analysis”, John Wiley & Sons, Inc. ©1990 (Ch. 2 and 7) and D. Powers, Yu Xie, “Statistical methods for Categorical Data Analysis”, Academic Press, ©2000. The referenced monograph described in the Agresti article is a non-exhaustive but rich and informative source for implementations. Concrete choice of association formulas and measures is application dependent. The results of an analysis can be presented to the user by a report generator 21 and/or memorized in a database of results 22.

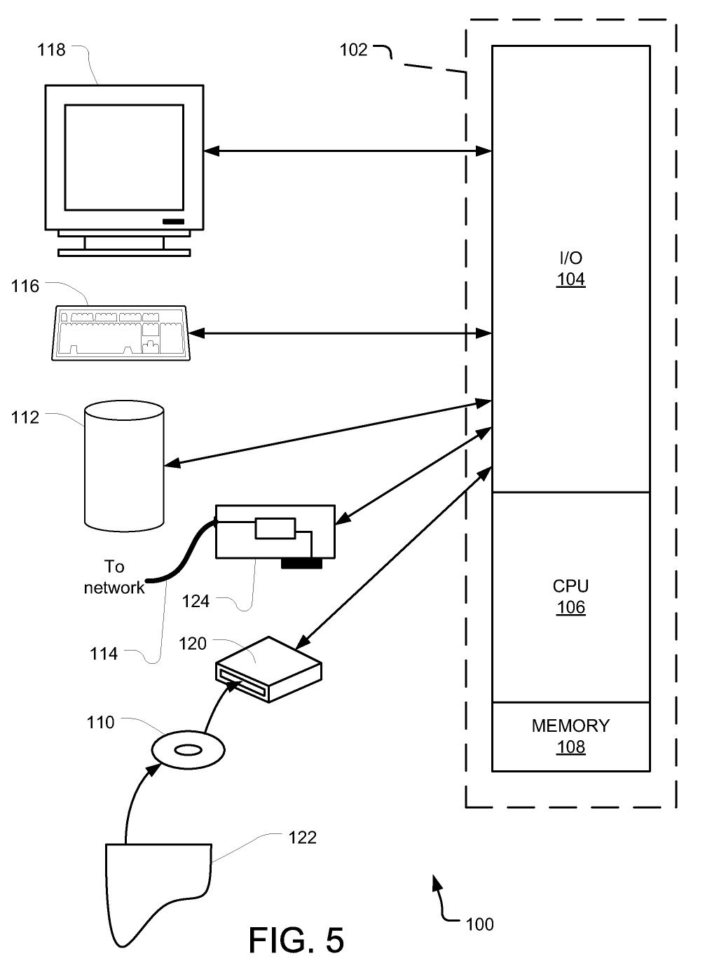

FIG. 5 illustrates an exemplary system useful in implementations of the described technology. A general purpose computer system 100 is capable of executing a computer program product to execute a computer process. Data and program files may be input to the computer system 100, which reads the files and executes the programs therein. Some of the elements of a general purpose computer system 100 are shown in FIG. 5 wherein a processor 102 is shown having an input/output (I/O) section 104, a Central Processing Unit (CPU) 106, and a memory section 108. There may be one or more processors 102, such that the processor 102 of the computer system 100 comprises a single central-processing unit 106, or a plurality of processing units, commonly referred to as a parallel processing environment. The computer system 100 may be a conventional computer, a distributed computer, or any other type of computer. The described technology is optionally implemented in software devices loaded in memory 108, stored on a configured DVD/CD-ROM 110 or storage unit 112, and/or communicated via a wired or wireless network link 114 on a carrier signal, thereby transforming the computer system 100 in FIG. 5 to a special purpose machine for implementing the described operations.

The I/O section 104 is connected to one or more user-interface devices (e.g., a keyboard 116 and a display unit 118), a disk storage unit 112, and a disk drive unit 120. Generally, in contemporary systems, the disk drive unit 120 is a DVD/CD-ROM drive unit capable of reading the DVD/CD-ROM medium 110, which typically contains programs and data 122. Computer program products containing mechanisms to effectuate the systems and methods in accordance with the described technology may reside in the memory section 104, on a disk storage unit 112, or on the DVD/CD-ROM medium 110 of such a system 100. Alternatively, a disk drive unit 120 may be replaced or supplemented by a floppy drive unit, a tape drive unit, or other storage medium drive unit. The network adapter 124 is capable of connecting the computer system to a network via the network link 114, through which the computer system can receive instructions and data embodied in a carrier wave. Examples of such systems include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 100 is connected (by wired connection or wirelessly) to a local network through the network interface or adapter 124, which is one type of communications device. When used in a WAN-networking environment, the computer system 100 typically includes a modem, a network adapter, or any other type of communications device for establishing communications over the wide area network. In a networked environment, program modules depicted relative to the computer system 100 or portions thereof, may be stored in a remote memory storage device. It is appreciated that the network connections shown are exemplary and other means of and communications devices for establishing a communications link between the computers may be used.

In an exemplary implementation, a converter module, an adaptive machine learning module, a counter-oriented query generator module, an analytical query module, an intersection evaluator algorithm module, a relation analyzer, a report generator module, a user-interface module, and other modules may be incorporated as part of the operating system, application programs, or other program modules. Indexes, counters, hash values, vectors, and other data may be stored as program data.

A processor, such as a pattern recognition processor, may be part of a general-purpose computer or a special-purpose computer, or an integrated circuit, such as an application-specific integrated circuit. For example, the processor can be implemented on a programmed general purpose computer to execute instructions and/or commands. The processor can also be implemented on a special purpose computer, a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA or PAL, or the like.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A system comprising:
an adaptive machine learning module comprising a pattern recognition processor, the pattern recognition processor configured to recognize searchable elements in source information and identify a semantic meaning of the searchable elements based on contingency measures of their relationships within the source information without requiring a predefined ontology of terms.

2. A system according to claim 1 wherein the pattern recognition processor is configured to identify the semantic meaning by discovering relations between the searchable elements by incrementing counters for a plurality of different combinations of the searchable elements using an index.

3. A system according to claim 2 wherein the counters comprise joint counters to determine set intersections of the searchable elements.

4. A system according to claim 1 wherein the adaptive machine learning module is further configured to generate descriptions of discovered relations of the searchable elements.

5. A system according to claim 4 wherein the descriptions of the discovered relations are in the form of a vector-weighted graph.

6. A system according to claim 5 wherein the vector-weighted graph is independent of a predefined ontology or user direction.

7. A system according to claim 5 wherein the adaptive machine learning module is further configured to alter a search algorithm based upon feedback from the vector-weighted graph.

8. A system according to claim 4 wherein the adaptive machine learning module is further configured to alter a search algorithm based upon feedback from the descriptions of the discovered relations of the searchable elements.

9. A system according to claim 4 wherein the descriptions of the discovered relations comprise at least one of a graphical representation, a textual representation, an application-oriented representation, and a numerical representation.

10. A system according to claim 1 wherein the index logically represents a hash map from integer keys to hash sets.

11. A system according to claim 9 wherein the index is configured to use joint counter to determine set intersections of searchable elements for relational discovery.

12. A system according to claim 1 wherein the source information comprises at least one of textual information, information stored in a relational database, XML documents, and scanned images.

13. A method of identifying a semantic meaning of searchable elements, the method comprising:
recognizing searchable elements in source information; and
identifying a semantic meaning of the searchable elements using a pattern recognition processor based on contingency measures of searchable element relationships within the source information without requiring a predefined ontology of terms.

14. A method according to claim 13 wherein the operation of identifying a semantic meaning comprises discovering relations between the searchable elements by incrementing counters for a plurality of different combinations of the searchable elements using an index.

15. A method according to claim 13 further comprising generating descriptions of discovered relations of the searchable elements.

16. A method according to claim 15 wherein the descriptions of the discovered relations are in the form of a vector-weighted graph.

17. A method according to claim 16 wherein the vector-weighted graph is independent of a predefined ontology or user direction.

18. A method according to claim 16 further comprising altering a search algorithm based upon feedback from the descriptions of the discovered relations of the searchable elements.

19. A method according to claim 16 further comprising altering a search algorithm based upon feedback from the vector-weighted graph.

20. A method according to claim 15 wherein the descriptions of the discovered relations comprise application-oriented representations.

21. A method according to claim 20 wherein the application-oriented representations comprise at least one of a chart, a graph, a textual explanation of the chart and a textual explanation of the graph.

22. A method according to claim 13 wherein the searchable elements comprise requested searchable elements.

23. A method according to claim 13 wherein the searchable elements comprise requested searchable elements and discovered searchable elements.

24. One or more computer-readable storage media encoding computer-executable instructions for executing on a computer system a computer process that identifies a semantic meaning of searchable elements, the computer process comprising:
recognizing searchable elements in source information; and
identifying a semantic meaning of the searchable elements using a pattern recognition processor based on contingency measures of searchable element relationships within the source information without requiring a predefined ontology of terms.

25. A database comprising:
a database index that logically represents a hash map from integer keys to hash sets, wherein the database index is configured to use joint counters to determine set intersections of searchable elements for relational discovery.
